(19) United States
(12) Patent Application Publication
(10) Pub. No.: US 2014/0322522 A1
(43) Pub. Date: Oct. 30, 2014

(54) B-STAGEABLE SILICONE ADHESIVES

(71) Applicant: Bayer MaterialScience AG, Leverkusen (DE)

(72) Inventor: Mikyong Yoo, Palo Alto, CA (US)

(21) Appl. No.: 14/349,718

(22) PCT Filed: Oct. 10, 2012
(86) PCT No.: PCT/US12/59452

§ 371 Date: Apr. 4, 2014

Related U.S. Application Data
(60) Provisional application No. 61/545,302, filed on Oct. 10, 2011.

(51) Int. Cl. C09J 183/04; B32B 37/06; B32B 7/12

(52) U.S. Cl. CPC C09J 183/04; B32B 7/12; B32B 37/06
USPC 428/327; 156/329; 156/273.5; 525/477

(57) ABSTRACT

The present invention relates to a B-stageable silicone adhesive having microencapsulation. The encapsulated B-stageable silicone adhesive allows lengthening the assembly time between applying the adhesive and lamination. Although exemplified with silicone adhesives, the inventive encapsulated adhesive concept has potentially broad applicability to other types of adhesives.

### RELATED APPLICATION

This application claims the benefit, under 35 USC §119(e), of U.S. provisional patent application No. 61/545,302, filed Oct. 10, 2011, entitled B-STAGEABLE SILICONE ADHESIVES, the entirety of which is incorporated by reference herein.

### FIELD OF THE INVENTION

The present invention relates in general to adhesives and more specifically to a B-stageable silicone adhesive for use in electronic film applications.

### BACKGROUND OF THE INVENTION

U.S. Published Patent Application No, 2007/0219285 in the name of Kropp et al., details an adhesive composition which is said to be useful for electronic assembly comprising a photopolymerizable acrylic resin containing polymerizable acrylate, a moisture-curable resin including an alkoxy or acyloxy silane terminated polymer, a photoinitiator for initiating polymerization of the acrylate, and a photoacid generator for catalyzing a moisture curing reaction of the alkoxy or acyloxy silane terminated polymer. Also provided are assemblies including such adhesives, such as electronic assemblies and radio frequency identification tags.

Kropp, in U.S. Published Patent Application No. 2008/0152921 provides an adhesive composition useful for electronic assembly comprising a curable epoxy resin, a plurality of polymer particles having at least one of a plurality of acid functional groups or a composition which swells in the presence of the epoxy resin at a first temperature and a thermally activated cure agent and/or a thermally activated cure catalyst which becomes active at a second, temperature, wherein the second temperature is higher than the first temperature. Also provided are assemblies including such adhesives and methods of assembling same.

U.S. Published Patent Application No. 2012/0067615 in the name of Blaiszik et al,, discloses an autonomic conductivity restoration system includes a solid conductor and a plurality of particles. The particles include a conductive fluid, a plurality of conductive microparticles, and/or a conductive material forming agent. The solid conductor has a first end, a second end, and a first conductivity between the first and second ends. When a crack forms between the first and second ends of the conductor, the contents of at least a portion of the particles are released into the crack. The cracked conductor and the released contents of the particles form a restored conductor having a second conductivity, which may be at least 90% of the first conductivity.

B-stage adhesives known in the art usually consist of a B-stage epoxy formulation or a pressure sensitive adhesive that can undergo a secondary curing step after application. These adhesives may require a high temperature and long curing time after the B-stage; conditions which may not be suitable for heat sensitive materials, such as electronics. Also, epoxy formulations do not offer good bonding for substrates having a low surface energy. These adhesives may also be provided in a film format, which requires manual assembly and high cost due to the loss of material in a so-called knock-out area. Even though printable pressure sensitive adhesive materials are available commercially, these materials do not provide permanent adhesion as the shear force is found to be much less than that of permanent adhesives. The present inventor has been unable to locate in commerce any B-stage adhesives which have proven to be suitable for use with silicone substrates.

Therefore, a need exists in the art for improved B-stageable adhesives, especially for use in the electronics industry.

### SUMMARY OF THE INVENTION

Accordingly, the present invention provides a B-stageable silicone adhesive using microencapsulation. The encapsulated B-stageable silicone adhesive allows increasing the assembly or work time between applying the adhesive and lamination. The inventive encapsulated adhesive concept has potentially broad applicability to other types of adhesives.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 illustrates one embodiment of the inventive process;

FIG. 2 is a photograph of an encapsulation material;

FIG. 3 depicts a plot of time versus viscosity data for an encapsulated adhesive of the present invention;

FIG. 4 is a photograph of a device used in loop tack testing;

FIG. 5 depicts a plot of time versus load data for loop tack testing;

FIG. 6 is a photograph of a modified loop tack testing set up;

FIG. 7 depicts a plot of loop tack data; and

FIG. 8 illustrates loop tack data regarding the work time of the formulation after application.

### DETAILED DESCRIPTION OF THE INVENTION

The present invention will now be described for purposes of illustration and not limitation. Except in the operating examples, or where otherwise indicated, all numbers expressing quantities, percentages, functionalities and so forth in the specification are to be understood as being modified in all instances by the term “about.” All quantities given in “parts” and “percents” are understood to be by weight, unless otherwise indicated.

The present invention provides an adhesive composition comprising a curable composition, wherein a first component is encapsulated within a plurality of polymeric particles and a second component is non-encapsulated.

In some embodiments of the present invention, the first component is an adhesive resin. In other embodiments, the first component and the second component may be different curable resins. In yet other embodiments, the first, encapsulated component contains a functional group which may be reacted with a functional group of the second, non-encapsulated component. in still other embodiments, the first, encapsulated component may serve as a catalyst capable of initiating a reaction involving the second component. In all cases, there may be additional components in the adhesive composition either encapsulated in the polymeric particles or non-encapsulated.

The present invention further provides an assembly comprising a first and second substrate and the inventive encapsulated adhesive adhering the first and second substrates.

The present invention yet further provides a method for assembly involving providing an encapsulated adhesive composition, providing a first and a second substrate, applying the encapsulated adhesive composition to one of the first substrate and second substrate, partially curing the encapsulated adhesive composition at a first temperature or irradiating the encapsulated adhesive composition with light, applying the other of the first substrate and the second substrate to the partially cured encapsulated adhesive composition and filly curing the encapsulated adhesive composition at a second temperature which is greater than the first temperature.

It should be noted that although the present invention is explained in the context of silicone adhesives useful for electronics components, those skilled in the art will recognize the inventive encapsulated adhesive concept has potentially broad applicability to other types of adhesives for a wide variety of applications.

The present invention is exemplified by a printable B-stageable silicone adhesive. Heretofore, commercially available printable liquid adhesives did not offer a sufficient degree of tackiness, which is preferred for use in the procedure of laminating-first-and-then-curing, especially of films under tensile strain. Although silicone adhesives can be pre-cured to offer the tackiness, this pre-cure allows only a very short working time between printing and lamination. This limited time window is hard to control, especially so in mass production processes.

As those in the art are aware, B-stage epoxy adhesives allow a limited reaction between resin and hardener to take place with the thickened resin remaining soluble, This soluble resin has a higher softening point and a more limited solubility than original, so it requires a very high temperature of softening and long curing time to reach a final cure. These conditions are not suitable for heat-sensitive substrates, such as electronics and electrically conductive films.

Both thermal B-staging, where solvent is removed or partial curing occurs by exposure to a specified thermal regime, and irradiation B-staging, where ultraviolet (UV) or another light source initiates a curing reaction to thicken the composition prior to contact and final curing, may be used with the encapsulated adhesive of the present invention.

In an embodiment, the adhesive of the present invention includes a soft gel-like silicone as a binder and a microencapsulated adhesive resin as a permanent adhesion agent. As those skilled in the art are aware, microencapsulation may be broken with heat. After the silicone gel is cured, preferably by UV or a lower heat than that required for breaking microencapsulation, the cured gel will provide tackiness with the properties of a low molecular weight silicone. Microencapsulated adhesive resin is stable at room temperature, and may provide the inventive adhesive with a relatively long period of sitting time before lamination. After lamination, additional heat treatment is preferably used to break the microencapsulation, enhance diffusion of the encapsulated resin, and cure the resin, leading to a permanent adhesion between the substrates.

Micro and nano encapsulants suitable for use in producing the encapsulated adhesives of the present invention are commercially available. For example, LipoCapsule™ gelatin product (available from Lipo Technologies, Inc.) is a clear, non-pigmented shell surrounding a hydrophobic core material. The shell may be made of gelatin, polyoxymethylene urea, or methoxymethyl methylol melamine. The LipoCapsule™ products may have a size of from 5 to 3,000 microns.

Other commercially available encapsulated particles include NanoSal™ nanospheres, which are solid hydrophobic nanospheres having an average particle size of 001 to 1 micron, and products from Sarek and Microtek Laboratories, Inc, with particle sizes up to 7,000 microns. Other shell chemistries are available, e.g. polyvinyl alcohol, urea and melamine formaldehyde polymers, acrylics, urethanes, polyurea, synthetic waxes, cellulose acetate butyrate, enteric coatings, and vinyl acetate copolymers (http://www.microteklabs.com/trechcapability.html).

The particle size is chosen based on the thickness of the adhesive bond desired and the type of adhesive to be encapsulated. For many applications, it should be smaller than the adhesive bond thickness but large enough to ensure that sufficient encapsulated resin can be incorporated into the bond. The shells of small, encapsulating particles may be so thick relative to the encapsulated volume that each particle would contain very little resin and it would not be possible to have a sufficiently high concentration of resin-filled particles in the adhesive formulation to deliver enough to create a strong adhesive bond. In some printed adhesive applications with an adhesive bond thickness of 50 microns, particles ranging in size from 5 microns to 30 microns are advantageous. In some embodiments, the particle size may be chosen to be larger than the adhesive bond thickness to enable a coating of the adhesive resin to escape and cover the surface of the binder to create a bond between the binder and a substrate material.

As diffusion of the hard resin is important for homogenous and permanent adhesion strength after the encapsulation is broken, the preferred binder is very soft with a large amount of opened network at the molecular level. Permeable silicone gel is a preferred gel with hardness of Shore 000˜Shore 0 scale. The adhesive resin, which will impart permanent adhesion, preferably has reactive groups and a hardness of shore A˜shore D.

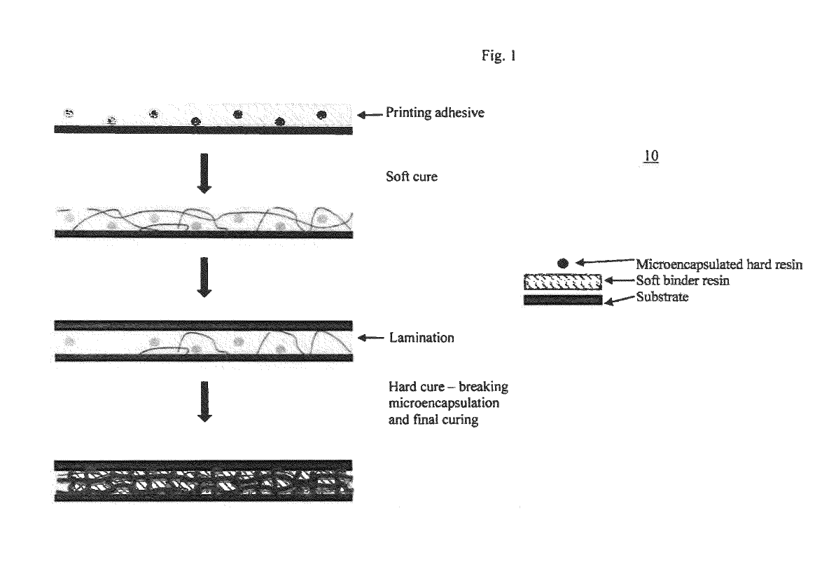

Permanent adhesion, a broad time window for lamination and printability are desirable for printing adhesives and laminating in mass production. An embodiment of the inventive process diagramed in FIG. 1 will satisfy those requirements.

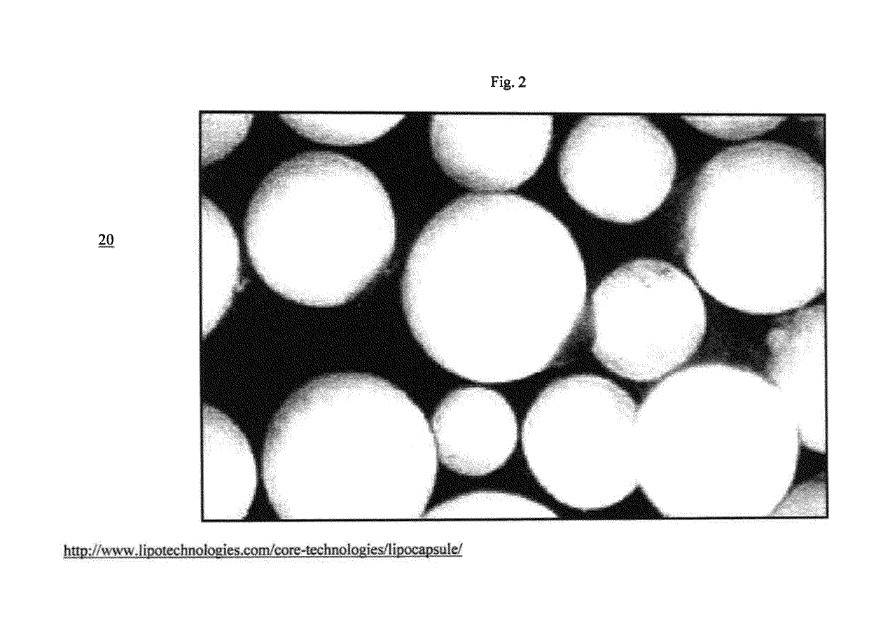

FIG. 2 is a photograph of a gelatinous encapsulation material useful in the present invention commercially available from Lipo Technologies, Inc. Without wishing to be limited by any particular mechanism, the present inventor believes such materials as gelatin, polyoxymethylene urea and methoxymethyl methylol melamine undergo one or more of the following release mechanisms: mechanical shear; pH; temperature (the shell is stable to 150° C., rupture can occur at the desired temperature range); slow release over time; and the addition of solvents or material to dissolve the shell. Other materials may degrade with irradiation such as ultraviolet (UV) exposure to rupture the capsules and release their contents. Limitations with such encapsulation materials may include: susceptibility to solvents including alcohols, glycols, ketones, hydrocarbons (gelatin); fragility at larger sizes; poor stability at pH extremes; the internal phase must be water insoluble and immiscible; and the material to be encapsulated should have a viscosity <5,000 cps.

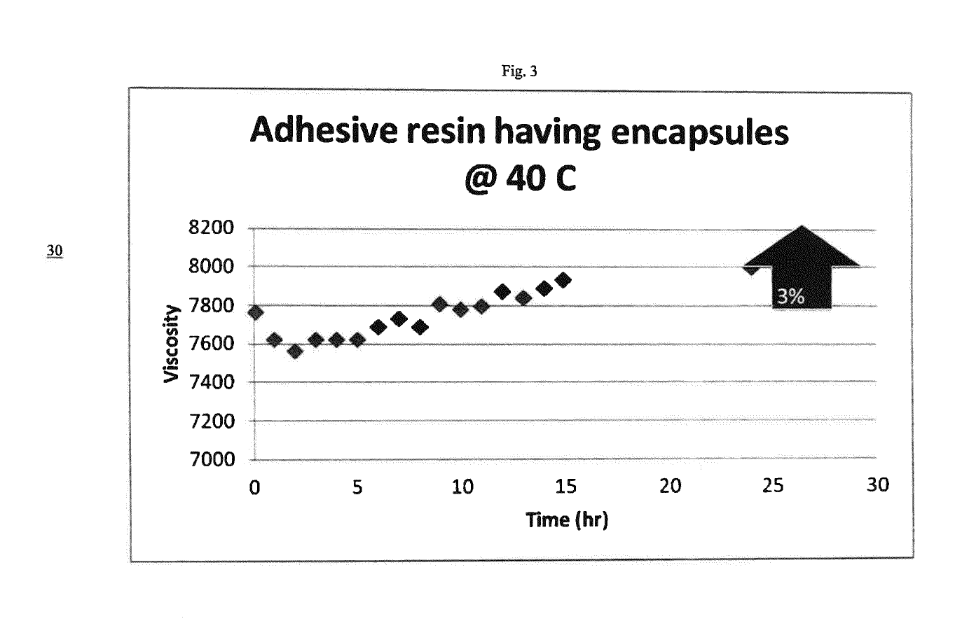

The adhesive composition of the current invention can have significant stability at low temperatures before use as shown in FIG. 3, a plot of time versus viscosity for an example of the inventive encapsulated adhesive which contains a shell of polyoxymethylene urea surrounding particles of a low consistency silicone elastomer adhesive (MED-6015 part B, commercially available from NuSil Technology of Carpinteria, Calif. USA having a viscosity of 90 cP). The inventive encapsulated adhesive has a particle size of approximately 20 microns and a rupture temperature of 150° C. After mixing with MED-6015 part A (also commercially available from NuSil Technology), the present inventor has found the mixture to be stable for at least five months under ambient conditions. Although some sedimentation has been observed, the mixture re-disperses well after hand mixing.

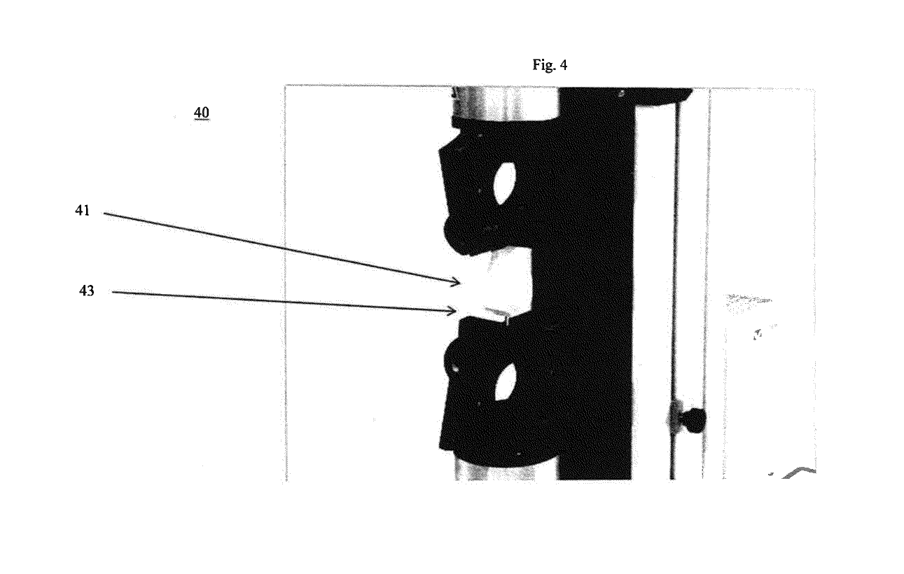

FIG. 4 is a photograph of a device used in adhesive loop tack strength testing according to ASTM D6195. As those skilled in the art are aware, this method is used to measure pressure sensitive adhesives applied to films, labels, tapes, and stickers where the initial tack force is an important characteristic of the product. As shown in FIG. 4, the adhesive 41 is placed on the outside of the looped film. The film adheres to a 1×1 square inch (2.54×2.54 cm) substrate 43.

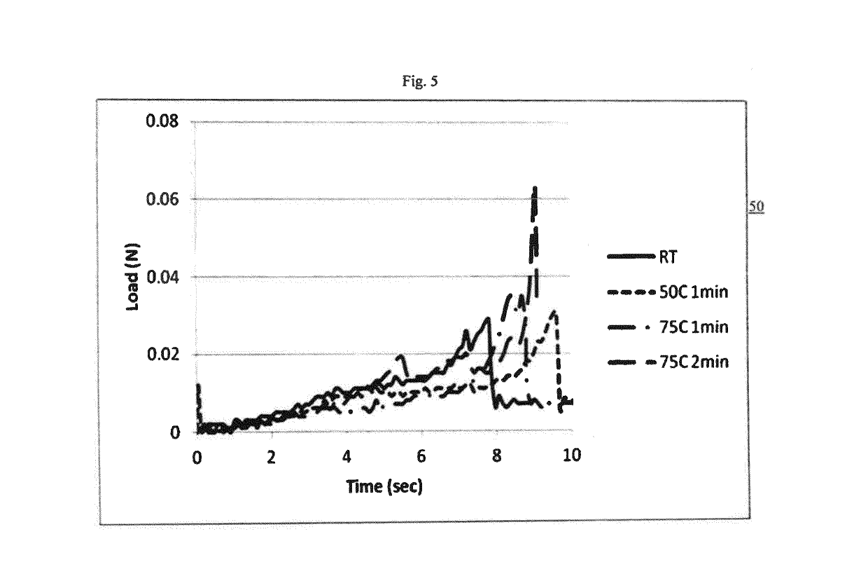

FIG. 5 depicts a plot of time versus load data for loop tack testing for the inventive adhesive composition. Film-to-film adhesives require tackiness for better lamination. The stability of tack is needed for long work time of printed adhesive. The data shown in FIG. 5 is from adhesives printed on films and pre-cured with different conditions and allowed to sit for one week before loop tack testing as follows: the solid line denotes room temperature curing; the dashed line denotes curing at 50° C. for one minute; the dashed-dotted line denotes curing at 75° C. for one minute and the long dash-short dashed line denotes curing at 75° C. for two minutes.

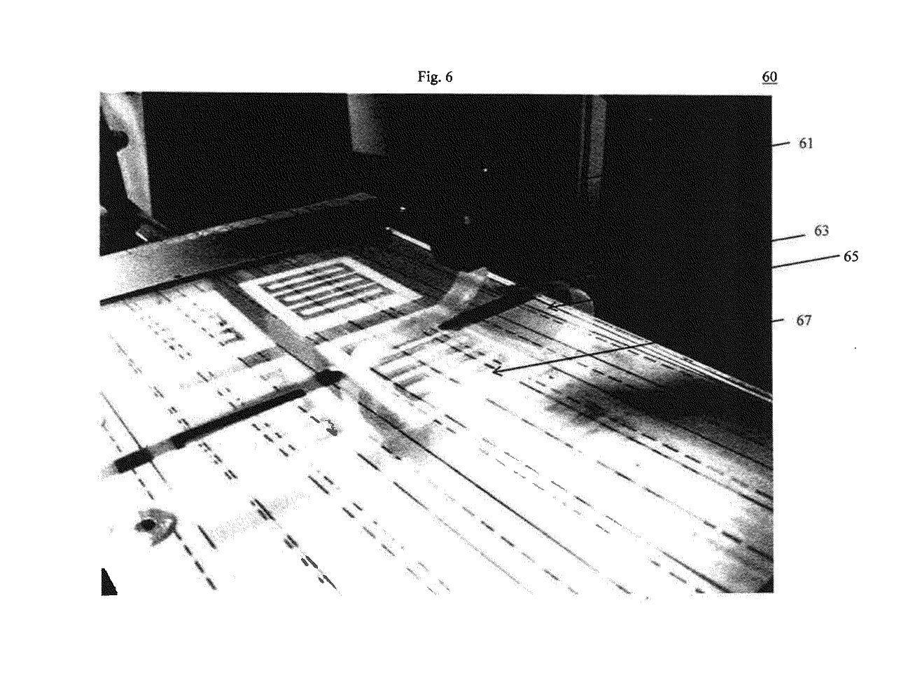

FIG. 6 is a photograph of a modified loop tack testing set up designed to provide a number for tack between adhesive and silicone film. ASTM D6195 uses looped adhesive tape and tests it on a specific substrate. The modified test was adapted for silicone film to silicone film adhesion in which adhesive was printed on one silicone film along with a special footprint matching a particular application. Because the present inventor wished to evaluate a ‘real’ adhesion strength with a particular adhesive footprint and found it was not possible to measure the loop tack by making a loop with the footprint as the silicone film was too soft and thin, ASTM D6195 was modified with a flipped-over configuration—using the adhesive footprint on the substrate and silicone-film-loop. The film 63 is faces outside with the polyethylene terephthalate support facing inside. A 36×7 mm² area with printed adhesive 67 is shown.

The following formulations were produced by combining the materials in the amounts given below and tested by modified loop tack testing:

### Example 1

### Base Formulation

| | Weight (part) |
|---|---|
| Low consistency silicone elastomer - part A | 50 |
| Encapsulated low consistency silicone elastomer - part B | 50 |

The low consistency silicone elastomer used is commercially available as MED-6015 from NuSil Technology of Carpinteria, Calif. USA. Part B was encapsulated with a polyoxymethylene urea shell in a proprietary process by Lipo Technologies, Inc. of Vandalia, Ohio USA,

### Example 2

### Non-Tacky B-Stageable Adhesive

| | Weight (part) |
|---|---|
| Base formulation from Ex. 1 | 50 |
| Silicone elastomer base | 50 |
| Silicone elastomer catalyst | 5 |

The silicone elastomer used is commercially available as SYLGARD 1-4128 from Dow-Corning of Midland, Mich. USA.

### Example 3

### Tacky B-Stageable Adhesive

| | Weight (per) |
|---|---|
| Base formulation Ex. 1 | 50 |
| Silicone adhesive sealant | 50 |

The silicone adhesive sealant used is commercially available as SS-5293-3000 from Silicone Solutions of Twinsburg, Ohio USA.

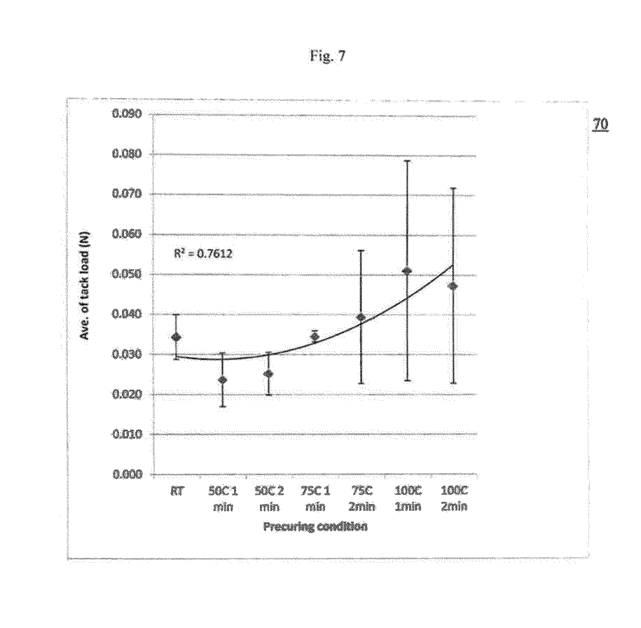

FIG. 7 depicts a plot of loop tack data. The data was collected one week after printing and pre-curing of the encapsulated adhesive. As can be appreciated by reference to FIG. 7, the inventive encapsulated adhesive has a good thermal. stability as well as work time after printing and requires an exposure to temperatures of 100 C to be activated.

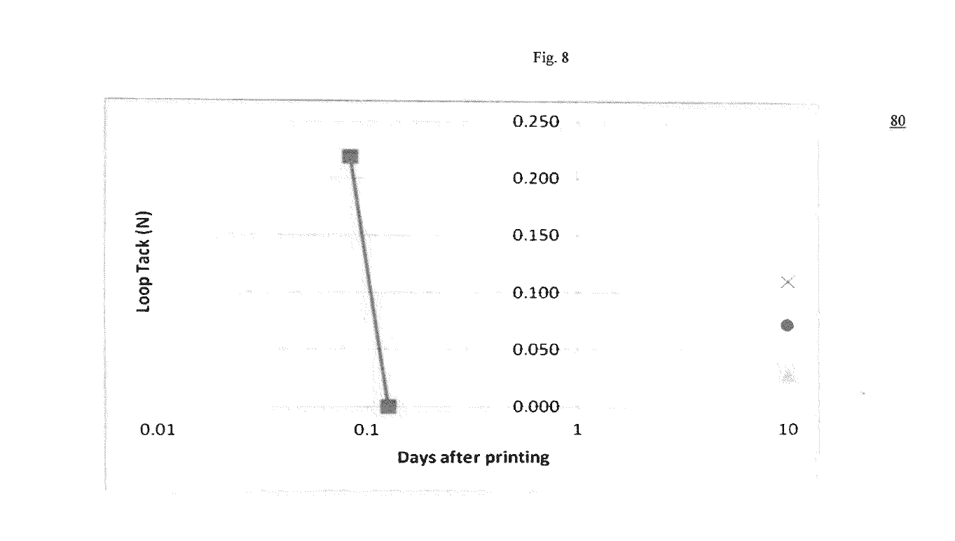

FIG. 8 illustrates loop tack data regarding the work time of the various encapsulated adhesive formulations. As can be appreciated by reference to FIG. 8, formulations with encapsulates have a good work time compared to MED-6033 (data shown in solid squares) which had a work time of three hours after printing and pre-curing at 75° C. for two minutes. Example 2 (data shown in solid triangles) was printed and cured at 100° C. for five minutes. The present inventor believes the adhesive composition of Example 2 may prove useful as a non-tacky B-stageable adhesive for film-to-film adhesive. The adhesive composition of Example 3 was printed and cured with UV with 225 mJ/cm² (1×) (data shown with a “•” —or 450 mJ/cm² (2×) (data shown with an “X”) and has enough initial tackiness combined with a longer work time. After laminating another film onto the adhesive, the material was cured at 150° C. for 4 minutes and provided a good bonding between films.

The present inventor believes the inventive encapsulation concept would be equally applicable to other B-stage adhesive chemistries such as acrylates, epoxies, polyurethanes, etc. and combinations of these materials.

As to other possible uses, the present inventor speculates that the inventive encapsulated adhesives may prove suitable for use in producing a self-healing film or electrode. For example, a rapidly curable silicone (less than 10 seconds) can be encapsulated, embedded in a film or an electrode and ruptured with localized heating due to dielectric breakdown or electrode cracking. This may be achieved by adding encapsulated adhesive when the film is coated, by adding encapsulated adhesive when the electrode is coated or by printing an overcoat containing encapsulated adhesive for the electrode.

One embodiment of the present invention is a tacky B-staged or ID temperature sensitive adhesive in which an adhesive resin is encapsulated and dispersed in a gel type soft adhesive which may be applied and cured at relatively low temperature (60˜80° C.) and have tackiness after cure. Following the first curing step, the adhesive would be very stable at room or moderate temperature. A liner may be applied and the material stored until needed. When required to be activated, the adhesive can be contacted by a heated substrate (˜100° C. or more depending on the rupture temperature of the encapsulant) and the increased temperature used to rupture capsules containing the encapsulated adhesive resin to provide a very strong adhesion to the substrate within a short period of time (e.g. <10 minutes depending on the curing temperature and kinetics of the encapsulated adhesive), Such an adhesive may enable the combination of different adhesive chemistries (e.g. silicone in the main resin and epoxy or acrylate in the capsules) for better affinity to different substrates i.e., a printed adhesive on one substrate and another to which the adhesive attaches).

Another embodiment of the present invention is a non-tacky B-staged adhesive in Which the adhesive is encapsulated and dispersed in a binder which can be cured at relatively low temperature (60˜80° C.) and lack tackiness after being cured. After the first curing, the binder is not tacky so that a liner, as detailed above, would not be required. This B-staged adhesive would be very stable at room or moderate temperature. When required to be activated, the adhesive can be contacted by a heated substrate (˜100° C. or more depending on rupture temperature) and the increased temperature would rupture capsules to provide a very strong adhesion to the substrate within a short period of time (preferably <10 min depending on the curing temperature and kinetics of the encapsulated adhesive). Depending on the substrates to which the adhesive should be adhered, encapsulated adhesives may use different chemistries (e.g. epoxy, acrylate, synthetic rubber).

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. An adhesive composition comprising a curable composition, wherein a first component is encapsulated within a plurality of polymeric particles and a second component is non-encapsulated.

2. The adhesive composition according to claim 1, wherein the first component comprises an adhesive resin.

3. The adhesive composition according to one of claims 1 and 2, wherein a functional group of the first component is reactive with a functional group of the second component.

4. The adhesive composition according to any one of claims 1 to 3, wherein the first component comprises a catalyst capable of initiating a reaction involving the second component.

5. The adhesive composition according to any one of claims 1 to 4, wherein the second component comprises a pressure-sensitive adhesive.

6. The adhesive composition according any one of claims 1 to 4 wherein the second component comprises a binder material capable of curing to a non-tacky state.

7. The adhesive composition according to any one of claims 1 to 6, wherein the first component is selected from the group consisting of silicones, epoxies, acrylates, polyurethanes and synthetic rubbers.

8. The adhesive composition according to any one of claims 1 to 6, wherein the first component comprises a catalyst for a reaction involving a material. selected from the group consisting of silicones, epoxies, acrylates, polyurethanes, styrenic copolymers, and synthetic rubbers.

9. The adhesive composition according to any one of claims 1 and 6, wherein the first component and the second component are independently selected from the group consisting of silicones, epoxies, acrylates, polyurethanes, and synthetic rubbers.

10. The adhesive composition according to any one of claims 1 to 9, wherein the polymeric particles are selected from the group consisting of gelatin, polyoxymethylene urea and methoxymethyl methylol melamine.

11. The adhesive composition according to any one of claims 1 to 10, wherein the polymeric particles have a size of from about 0.1 microns to about 7,000 microns.

12. The adhesive composition according to any one of claims 1 to 10, wherein the polymeric particles have a size from about 5 microns to about 30 microns.

13. An assembly comprising:
a first substrate;
a second substrate; and
the adhesive composition according to any one of claims 1 to 12 adhering the first and second substrates.

14. A method for assembly comprising:
providing the adhesive composition. according to one of claims 1 to 12;
providing a first substrate and a second substrate;
applying the adhesive composition to one of the first substrate and second substrate;
partially curing the adhesive composition at a first temperature or by irradiating the adhesive composition with light;
applying the other of the first substrate and the second substrate to the adhesive composition; and
exposing the adhesive composition to a second temperature which is greater than the first temperature or irradiating the adhesive composition with light.

15. The method according to claim 14, further comprising irradiating the adhesive composition with light after exposure to the second temperature.

16. The method according to one of claims 14 and 15 wherein the first temperature is from about 60° C. to about 80° C. and the second temperature is about 100° C. or more.

17. The method according to one of claims 14 and 15, wherein the light comprises ultraviolet light.
